(19) United States
(12) Patent Application Publication
(10) Pub. No.: US 2004/0238547 A1
(43) Pub. Date: Dec. 2, 2004

(54) Molded storage container with in-molded dry erasable surface

(75) Inventors: Lori Tyra, Medina, OH (US); Thomas Hanna, Willoughby, OH (US)

Correspondence Address: MARSHALL, GERSTEIN & BORUN LLP, 6300 SEARS TOWER, 233 S. WACKER DRIVE, CHICAGO, IL, 60606, US

(73) Assignee: RUBBERMAID INCORPORATED, Fairlawn, OH (US)

(21) Appl. No.: 10/889,524

(22) Filed: Jul. 12, 2004

Related U.S. Application Data
(62) Division of application No. 10/216,966, filed on Aug. 12, 2002.

(51) Int. Cl. B29C 31/00

(52) U.S. Cl. 220/675

(57) ABSTRACT

A molded article of manufacture has an article body and a discrete surface structure in-molded in a surface of the body. The discrete surface structure has an exposed surface that is repeatedly markable and erasable such that it can be marked with information and can be erased multiple times. The discrete surface structure is placed in a mold cavity and in-molded as a part of the article body with the erasable surface exposed.

### FIELD OF THE INVENTION

The present invention is directed to consumer markable and erasable surfaces for use with consumer products, and more particularly to a surface that can be in-molded during fabrication of an article of manufacture and that can be repeatedly marked and erased by the consumer.

### BACKGROUND OF THE INVENTION

Many household products or articles are stored for periods of time by consumers for use at a later date, whether stored for short or long periods. Such products are often labeled to assist in identifying the stored items. In addition, many other household articles and surfaces are provided with markable surfaces either for writing temporary information thereon or simply for providing a markable surface for use as entertainment.

In one example, plastic, reusable containers have been popular for quite some time for briefly storing perishable items such as leftover foods and baked goods. Larger plastic containers have more recently become popular for storing a myriad of different non-perishable items. To illustrate, consumers often will temporarily and periodically store seasonal items such as clothing, sports equipment, lawn and garden tools, and the like. In another example, consumers will store items such as memorabilia, baby clothes, and the like for indefinite periods of time. Also, consumers are often now using plastic, reusable storage containers to organize products and clutter within their home, whether or not the items are used regularly or infrequently.

Plastic containers are reusable and intended to last for long periods of time. Thus, most containers will hold many different products during their useful life. If a container is to properly identify the contents each time it is used, it is highly desirable to mark the container each time it is used.

Many consumers will label or otherwise mark storage containers to easily identify what items are stored in a given container. Typically, identification markings are written by a consumer directly on a container surface using a marking pen. Most writing instruments will not leave clearly visible marks on plastic materials. Thus, permanent ink markers are often used. Sometimes consumers will apply adhesive labels, decals, or pressure sensitive labels on the containers and then mark the labels with identification information. Such labels and decals eventually wear out or lift from the article. Consumers will still very often mark such labels with permanent ink markers.

It is well known that identification markings created using permanent ink markers are not erasable. Therefore, the consumer has few options. The consumer can cross out the last markings, and add a new marking to the container. This option will fairly quickly leave the container looking unattractive and little visible space for new markings. Also, the more crossed out marking on the container, the more difficult it will become to easily locate and read the most recent marking.

Another option is to apply an adhesive or pressure sensitive label over the original markings and re-mark the container using the label. A third option is to simply use an adhesive or pressure sensitive label instead of marking directly on the container. However, in either case, it can be very difficult to remove an old label from a plastic container. Additional labels can be applied directly over old labels and remarked. However, the stack of labels will very quickly become too thick and difficult to write on, and will be unattractive. The label can be reused by crossing out prior markings and adding new markings as needed. However, the label will quickly become cluttered, difficult to read, devoid of writing space, and unattractive. Further, adhesive labels can dry out and begin to pull away from the container, and can be damaged upon contact with objects, and can become dislodged or difficult to read if it becomes wet.

One solution has been proposed for use on reusable videocassettes as disclosed in, for example, U.S. Pat. No. 5,186,499 to Mason. An adhesive label is disclosed for application to the tape housing, wherein the label is made for use with dry erase markers. Such dry erase adhesive labels still are susceptible to many of the problems mentioned above for standard adhesive labels, except that information can be marked and erased a number of times, as needed.

Other dry erase adhesive labels and systems are disclosed in, for example, U.S. Pat. Nos. 5,024,898; 5,727,818; and 4,757,901. Each of these patents discloses adhesive or stick-on dry erasable labels for objects such as video cassettes, computer disks, and the like.

### BRIEF DESCRIPTION OF THE DRAWINGS

Objects, features, and advantages of the present invention will become apparent upon reading the following description in conjunction with the drawing figures, in which:

FIG. 1 shows a perspective view of one example of an article in the form of a storage container constructed in accordance with the teachings of the present invention.

FIG. 2 shows an end view of the storage container of FIG. 1.

FIG. 3 shows a perspective view of one example of a lid for the storage container of FIG. 1.

FIG. 4 shows a side view of another example of a storage container constructed in accordance with the teachings of the present invention.

FIG. 5 shows an enlarged cross section of a wall portion of a container constructed in accordance with the teachings of the present invention and including one example of an in-molded label.

FIG. 6 shows an enlarged cross section of a wall portion of a container constructed in accordance with the teachings of the present invention and including another example of an in-molded label.

FIG. 7 shows an enlarged cross section of a wall portion of a container constructed in accordance with the teachings of the present invention and including yet another example of an in-molded label.

FIG. 8 shows an enlarged cross section of one example of a portion of a mold block section constructed in accordance with the teachings of the present invention.

FIG. 9 shows an enlarged cross section of another example of a portion of a mold block section constructed in accordance with the teachings of the present invention.

FIG. 10 shows an enlarged cross section of still another example of a portion of a mold block section constructed in accordance with the teachings of the present invention, and including a robotic arm inserting a label into the section.

FIG. 11 shows a flow chart of one example of a method of manufacturing an article having an in-molded erasable label.

### DETAILED DESCRIPTION OF THE PREFERRED EMBODIMENTS

Articles of manufacture are disclosed herein that have at least one surface or surface portion that can be easily marked and erased numerous times by a consumer. Such a surface is substantially permanently in-molded into a wall or panel of an article and thus remains as a part of the article. A disclosed example of such an article is a storage container, and a disclosed example of such a markable surface is a label. The term “label” is used herein to define a discrete erasable, markable, and reusable surface, but discrete surfaces other than labels can also be added to articles in accordance with the teachings of the present invention. In one example, the discrete markable surface is dry erasable and adapted for use with dry erasable ink markers. The form of the molded article and the markable surface can vary considerably and can include virtually any object that may require or that might be improved by incorporating a reusable, markable surface.

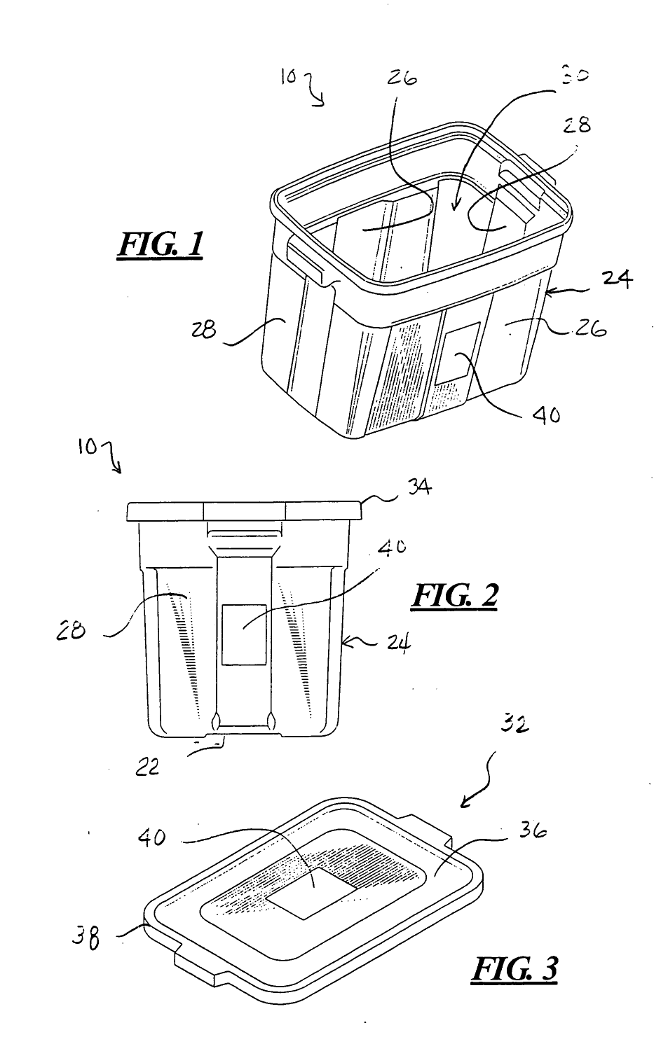

Referring now to the drawings, FIGS. 1 and 2 show a plastic molded article in the form of a storage container 20. The disclosed container 20 in this example has a bottom surface 22 and an integral, continuous upstanding side wall 24 extending upward from a perimeter of the bottom surface. In this example, the side wall 24 is formed having a pair of side panels 26 and a pair of end panels 28 that are integrally interconnected. The panels 26 and 28 are configured and arranged such that the side wall 24 defines a substantially vertically oriented rectangular cylinder in this example. A storage space 30 is formed by the bottom surface 22 and the side wall 24.

FIG. 3 illustrates one example of a lid 32 constructed and arranged to sealingly engage with a top perimeter 34 of the side wall 24 of the container 20. The lid 32 has a cover surface 36 and a perimeter edge configured to engage the top perimeter 34 of the side wall 24.

As will be evident to those having ordinary skill in the art, the container 20, lid 32, or other such molded articles can be fabricated from one or more numerous materials. For example, the container 20 and/or the lid can be fabricated from polypropylene, polyethylene, polystyrene, polycarbonate, polyethylene terephthalate or other such suitable materials. The only limitation is that the article material be suited to a molding or similar process such that a markable surface can be in-molded into the article during manufacture.

As illustrated in FIGS. 1-3, a markable, erasable, and reusable surface can be provided in a portion of a surface of the article. In the disclosed example, the markable surface is an erasable label 40 that is in-molded into a surface of the container 20. However, other types of markable surfaces are intended to fall within the scope and spirit of the present invention. For example, a plastic tray or tabletop can be fabricated including an in-molded surface which can be marked and erased as desired. Such a surface can provide entertainment for children when using the tray or tabletop. Other types of products with in-molded, erasable and markable surfaces can also be utilized.

FIG. 1 shows a label 40 molded into a side panel 26 of the container. FIG. 2 shows an alternative example wherein the label 40 is molded into an end panel 28 of the container. FIG. 3 shows a further alternative example wherein the label 40 is molded into the cover surface 36 of the lid 32. It is clear that the container 20 can either have multiple labels 40 provided in one of the panels or surfaces, or, as shown, have a label 40 provided in two or more of the different panels or surfaces, as needed for a particular application.

As will be evident to those having ordinary,skill in the art, the form of the article can vary considerably. As shown in the example of FIG. 4, the article can be a food storage container 50 having a base or bowl portion 52 and a lid or cover 54. One or more labels 40 or other markable surfaces can be in-molded into either or both a base surface (shown) or a cover surface (not shown). In this example, the container 50 is a circular cylindrical bowl or storage tub for keeping fresh any food or other contents stored in the container.

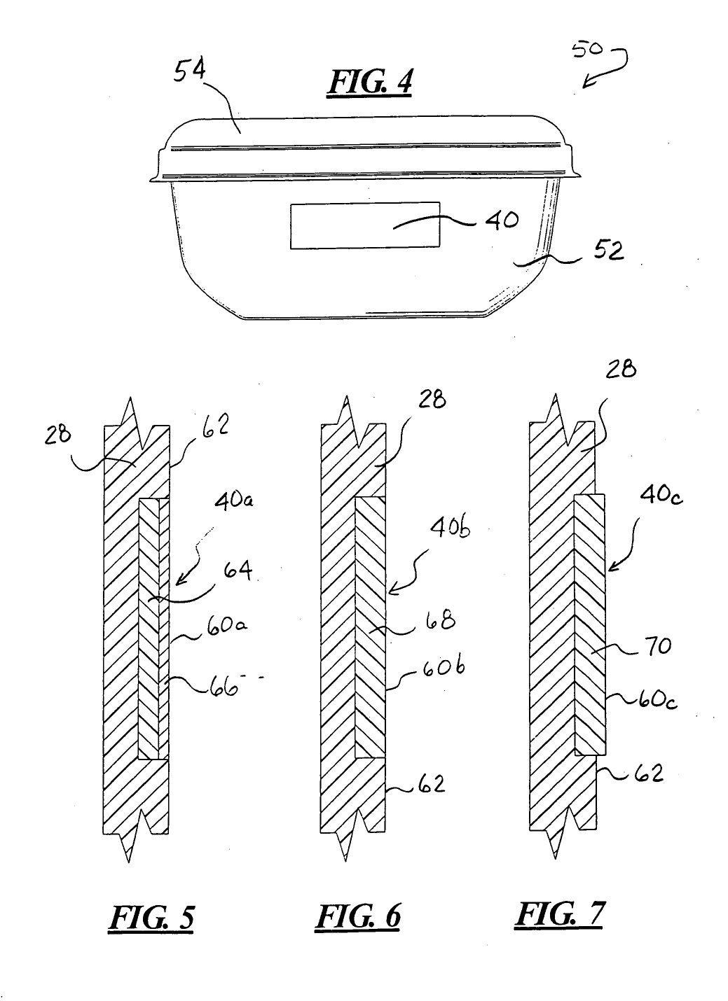

Turning to FIGS. 5-7, several examples of molded articles with in-molded markable label surfaces are shown. FIG. 5 illustrates a portion of a panel in cross section. For purposes of this description, in one example, the panel cross section can represent an end wall 28 of the container 20 and can include a label 40a that is in-molded therein as is shown in FIG. 2. In this example, the label 40a has an outwardly exposed label surface 60a and is in-molded such that the exposed label surface is flush or co-planar with an exterior surface 62 of the panel 28. The disclosed label 40a is shown having a multi-layer construction including a first or base layer 64 and an outer layer 66. The outer layer 66 defines the exposed label surface 60a.

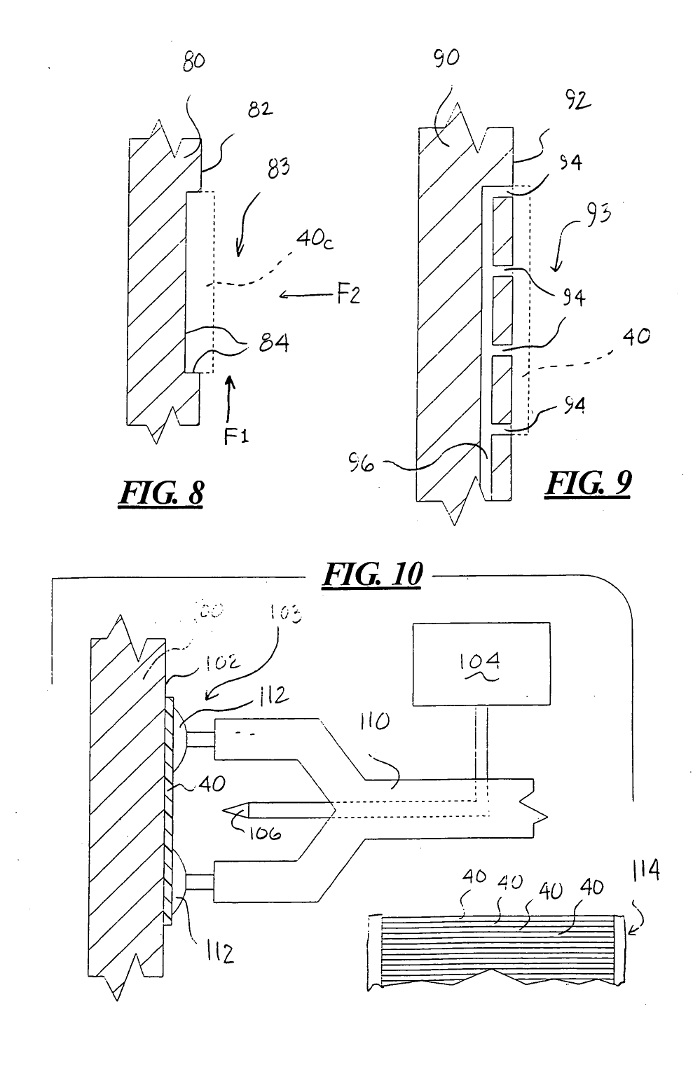

FIG. 6 illustrates an identical portion of an end panel 28 having a similar in-molded label arrangement. The label 40b in FIG. 6 is constructed having a single material layer 68 defining the exposed label surface 60b. The material layer 68 is contiguous and the exposed surface 60b is flush or co-planar with the panel exterior surface 62.

FIG. 7 illustrates an identical portion of an end panel 28 having an alternative, similar in-molded label arrangement. The label 40c in FIG. 7 is constructed having a single material layer 70 identical to the label 40b. The label 40c in this example defines the exposed label surface 60c. However, in this example, the label surface 60c is positioned outward or forward from the plane of the exterior panel surface 62. Thus, FIG. 7 illustrates an example of an in-molded label 40c that is raised relative the surface 62 of the panel 28.

The erasable and markable surface materials, such as for the labels 40 described above, can vary considerably and yet fall within the spirit and scope of the present invention. It is an intended goal of the disclosure that the markable surface be one that can be erased or cleaned and then re-marked. There are many types of surfaces that can be written or drawn on utilizing a marking device such as a pen, pencil, ink marker, and the like and that can then be cleaned to remove the markings. Such surfaces can be erased or cleaned using a dry rag or sponge, a wet rag or sponge, a cleaning solvent or chemical, or other such cleaning paraphernalia. The present invention is intended to encompass labels 40 and other such surfaces that can be marked and cleaned in such fashion.

In one example, the surface or label 40 is adapted for use with markers known as “dry erasable” ink markers. Such markers are useful on surfaces wherein the ink can be dry wiped from the surface without the need for using water, solvents, chemicals, or even a sponge or rag. The ink and surfaces are designed to be easily marked and erased simply by wiping the markings with a hand or a finger. One example of such a dry erase surface is an ultraviolet cured surface coating or layer available from Romo, Inc. of De Pere, Wis. The coating is known as ZYNICAST™ and is a coating that can be added to base materials to render them dry erasable. Other materials may be available or may be later developed that are dry erasable and can be formed as a single unitary material layer, and yet meet cost and in-molding requirements.

A base label material that is suitable for in-mold labeling processes can be treated to add such a dry erasable coating or layer. Examples of base materials suitable for in-mold processes include, for example: IML 103 (a corona treated, flexible matte, clear opaque, polyolefin film available from MPI Label Systems of Sebring Ohio); IML 200 (KIMDURA™ white in-mold label material available from MPI); TS-100 (white TESLIN® material available from PPG Industries). Other suitable base materials include Romo PE/PP blend clear 7 mil base label material, GRAFILM™, or the like.

A base label material suitable for use with a dry erasable clear coating is available from Romo, Inc. and is known as REZYLITE™. Such a dry erase label has a polyethylene/polypropylene blend white base and a UV cured clear coat dry erase coating. Depending upon a particular application, the formulation for the clear coat and the base blend can be altered to achieve particular characteristics and to accommodate various molding or curing process parameters.

As will be evident to those having ordinary skill in the art, the selected label or erasable surface materials can vary according to the needs of a particular process and article. Some molding processes or articles may require an in-mold product material withstand certain molding temperatures, or be compatible with specific molding materials. Other processes and articles may not be as sensitive.

The above exemplary articles with in-molded erasable and markable surfaces can be fabricated utilizing any suitable molding process. For example, blow molding, injection molding, injection blow molding, continuous extrusion blow molding, injection stretch blow molding, compression molding, and the like can be utilized to fabricate articles with in-molded erasable and markable surfaces. The invention is not intended to be limited to only a particular molding process.

In any process, the in-molded label can be prepared and provided prior to placement in the mold cavity of a mold. This may be preferable because, once an article is molded, it may be more difficult, cumbersome, or even impossible to perform any necessary operations to create and complete the markable surface. The article size, structure, and material surrounding the markable surface may hinder or prevent such operations. However, it is within the purview of the present disclosure to in-mold less than all layers of a markable surface, or to require further treatment of the surface, such as UV curing, after the article is fabricated.

FIGS. 8-10 illustrate alternative mold constructions in simplified form for fabricating an article with an in-molded label. An exemplary blow molding process is useful to fabricate the articles described herein. In these examples, portions of mold block sections are illustrated as fabricated from a metal material. The material used to manufacture the mold blocks segments can vary considerably and can include steel, aluminum, alloys, and even non-metallic materials such as composites and the like. Also, the mold cavity construction created by two or more closed mold blocks can vary in size, shape, depth, article wall thickness, and other characteristics according to the needs of a particular article and according to the process used.

With reference to FIG. 8, a part of a mold block section 80 is illustrated. The mold block section 80 has an interior surface 82 facing and defining, in part, a mold cavity 83. A recessed region 84 is formed, such as by machining, in a chosen location on the interior block surface 82. The recessed region is of a size and shape to accommodate a label 40 or other erasable, markable structure to be in-molded. The depth of the recessed region 84 shown in the drawing is exaggerated to simplify illustration and explanation of this example. However, the depth need only be sufficient for a label 40 or other structure to register therein.

During a molding process, a plastic material is introduced into the mold cavity 83. Depending upon the mold process being utilized and direction of flow of the material, the label 40 may require a positive holding feature to retain the label in place within the cavity until the material has completed filling the cavity 83.

As shown in FIG. 8, molding material can flow either parallel to the label and cavity surface (see arrow F₁), or perpendicular to the label and cavity surface (see arrow F₂). In some processes and applications, the material may flow at a different acute or obtuse angle relative to the label and cavity surface. If flowing perpendicular to the surface and label, a holding feature may not be necessary to hold the label in place. Pressure from the molding material against the label may be sufficient to hold it in place.

FIG. 8 illustrates one example of such a holding feature. The label 40 will be retained in place by registering in the recessed region 84. FIG. 8 illustrates the label 40c in phantom view, whereas the finished molded article panel 28 will have a slightly protruding label 40c as shown in FIG. 7. The label 40c can either be a single layer or a multilayer construction.

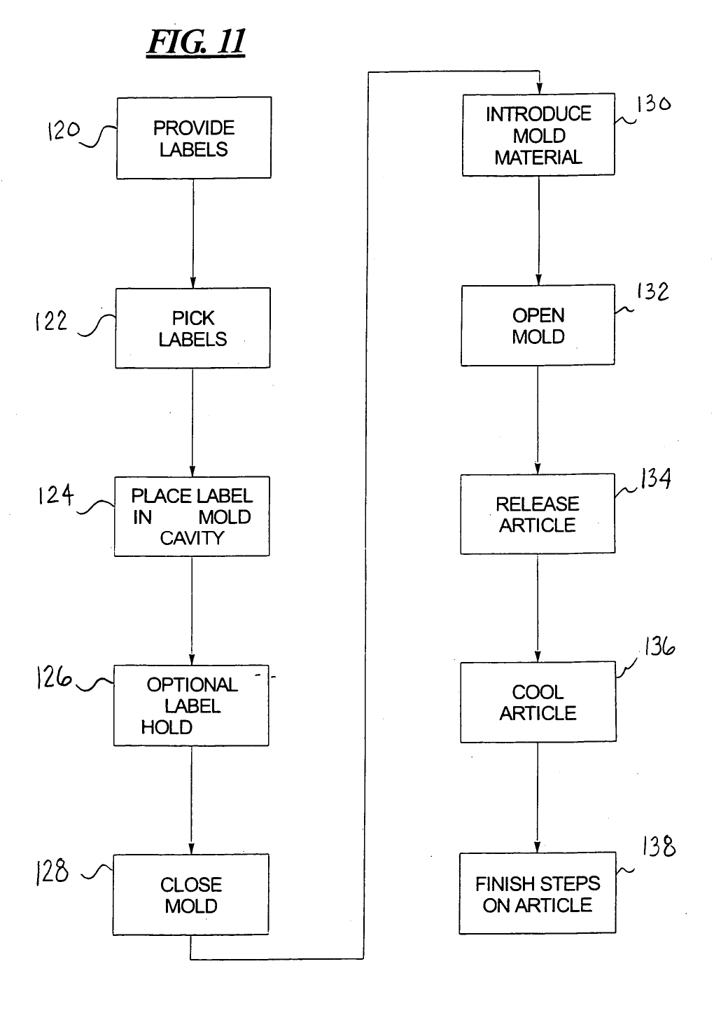

FIG. 9 illustrates an alternative holding feature that can be utilized. In this example, a mold block section 90 has an interior surface 92 facing into and defining, in part, a mold cavity 93. A plurality of air nozzles 94 are provided within the mold block section in communication, at one end, with the interior surface 92 and cavity 93. The opposite ends of the nozzles 94 are in communication with a passage 96 extending along the mold block section. The passage 96 is in communication with a vacuum source (not shown). A vacuum is applied to the nozzles 94 upon insertion of a label 40b within the cavity 93 over the nozzles 94. The vacuum will hold the label 40 in place during fabrication of an article within the cavity. The arrangement shown in FIG. 9 will produce a molded article with a label 40a or 40b as shown in either of FIGS. 5 or 6, depending upon the label construction.

FIG. 10 illustrates another alternative holding feature that can be utilized. In this example, a mold block section 100 has a smooth interior surface 102 facing into and defining, in part, a mold cavity 103. A selected label 40 is placed in the proper position in the cavity against the interior surface 102. A static charging device 104 is provided having a charging head 106 that can be placed near, but not in contact with, the label 40. A pulse is applied by the charging device 104 to the head 106. A static charge results in the label 40. The label is then held in place within the cavity by static electricity during fabrication of an article. Suitable static charging devices are commercially available from manufacturers, such as Simco Industrial Static Control, for example.

As will be evident to those having ordinary skill in the art, the method by which a selected label 40 or other erasable and markable structure is picked and placed can vary considerably. In one example, the procedure can be done entirely by hand or manually. In an alternative example, the process can be automated and include process controls, computers, and the like. FIG. 10 illustrates a simplified schematic of such an automated procedure. A robotic arm 110 in this example has a plurality of suction cups 112 in communication with a vacuum source (not shown). The arm 110 can moved by an automated controller (also not shown) to a magazine 114 containing a plurality or stack of labels 40. The first available label 40 is captured by the suction cups 112 and the arm 110 is moved to the cavity 103.

The label is placed in its proper location and then held by appropriate means. As shown in this example, static electricity is applied by the charging head 106 to hold the selected label in place. Alternatively, another suitable holding feature can be utilized as well, as described above for example. Once the selected label 40 is placed in the cavity 103 and appropriately held in place, the suction cups 112 release the label 40. The article fabrication process can then be performed by introducing molding material to the cavity 103.

FIG. 11 illustrates a flow chart of one example of a method to fabricate an article of manufacture having an in-molded erasable label. At block 120, a plurality of labels 40 or other erasable and markable surfaces are provided. As described above, the labels can be provided in stacks or magazines, ready to be used.

At block 122, a selected label or labels 40 are picked from a supply of labels, such as the magazine 114. The picking step can be performed using any suitable device or means, and can be done manually or automatically. As shown in FIG. 10, an automated picker, such as the robotic arm 110, can be used to pick and move a selected label.

At block 124, the selected label or labels 40 are moved to the mold cavity and placed within the cavity in a predetermined or desired location. In the example disclosed herein, the label is moved using the robotic arm 110 and placed in position in the cavity. The arm then releases the label.

At blocks 126 and 128, a holding feature is implemented, if necessary, to hold the label in place, and then the mold is closed. The holding feature can vary as described above, and depending upon the type of hold used or needed, the hold feature can be implemented either prior to, during, or after the mold is closed. For example, if the recessed region 84 is used, the hold feature is inherent and implemented before the mold is closed. If either the vacuum or static hold is used, the vacuum or static electricity can be applied either before, during, or after the mold is closed.

At block 130, the mold material that is used to form the molded article is introduced into the mold cavity. The type of introduction will depend upon the type of molding process being used. For example, if an injection mold process is being utilized, molten material will be injection into gates in the mold cavity. If a blow molding process is used, a parison is introduced into the cavity and then air pressure is used to “blow” or push the material against the cavity walls. Combinations of these introduction techniques, as well as other techniques, can also be utilized.

Upon completion of the introduction step and sufficient time elapsed, the mold can be opened, as referenced at block 132. The article can then be released from the mold cavity, as referenced at block 134. At block 136, the article can be cooled as needed. The cooling step can be partly or completely performed before, during, or after the article is released from the mold.

The article is then subjected to necessary or desired finish operations, as referenced at block 138, to complete the article fabrication process. Machining, trimming, flash reduction, curing, or other operations can be performed, depending upon the type of article produced, the materials used, and the molding process performed.

Although certain labels or markable and erasable surfaces, methods, and articles of manufacture have been disclosed and described herein in accordance with the teachings of the present invention, the scope of coverage of this patent is not limited thereto. On the contrary, this patent covers all embodiments of the teachings of the invention that fairly fall within the scope of permissible equivalents.

1. A molded storage container comprising:
a container body having a storage interior and an exterior surface; and
a discrete surface structure having an exposed dry erasable surface molded in the exterior surface of the body,
wherein the exposed dry erasable surface can be marked with information and can be erased and re-marked multiple times.

2. (Canceled)

3. A molded storage container according to claim 1, wherein the container body has a bottom panel and a continuous upstanding sidewall forming the exterior surface.

4. A molded storage container according to claim 1, wherein the container body is formed from a material selected from a group of materials comprising polypropylene, polyethylene, polystyrene, polycarbonate, and polyethylene terephthalate.

5. A molded storage container according to claim 1, wherein the exposed dry erasable surface is a substantially blank white surface.

6. A molded storage container according to claim 5, wherein the exposed dry erasable surface is a dry erasable coating carried by the discrete surface structure and is adapted for use with dry erasable inks.

7. A molded storage container according to claim 1, wherein the container body has a base and a removable lid, and wherein the discrete surface structure is molded into a surface of the base.

8. A molded storage container according to claim 1, wherein the container body further includes a removable lid, and wherein the discrete surface structure is molded into a surface of the lid.

9. A molded storage container according to claim 1, wherein the container body is a plastic storage container having a base container and a lid, and wherein the discrete surface structure is molded into an exterior surface of either the base container or the lid.

10-19. (Canceled)

20. A storage container comprising:
a plastic container body;
a base material layer in-molded as part of the molded container body; and
an exposed dry erasable surface on the base material layer, wherein the exposed dry erasable surface can be repeatedly marked and erased with information using dry erasable inks.
